(19) United States
(12) Patent Application Publication
(10) Pub. No.: US 2005/0219995 A1
(43) Pub. Date: Oct. 6, 2005

(54) Write-once information recording medium

(76) Inventors: Seiji Morita, Yokohama-shi (JP); Koji Takazawa, Tokyo (JP); Naoki Morishita, Yokohama-shi (JP); Naomasa Nakamura, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/088,761

(22) Filed: Mar. 25, 2005

(30) Foreign Application Priority Data
Apr. 2, 2004 (JP) 2004-110386

(51) Int. Cl. G11B 7/24

(52) U.S. Cl. 369/275.4; 428/64.4

(57) ABSTRACT

A write-once optical disk comprises a transparent resin substrate having a concentrically or spirally shaped groove and a land formed thereon, and a recording film formed on the groove and the land of the transparent resin substrate, a recording mark being formed by emission of a short-wavelength laser light beam. In addition, a light reflectivity of the recording mark portion formed by emission of the short wave laser light beam is higher than a light reflectivity obtained before emission of the short wavelength laser light beam, and a depth of the groove is in the range of 50 to 80 nm.

### CROSS-REFERENCE TO RELATED APPLICATIONS

This application is based upon and claims the benefit of priority from prior Japanese Patent Application No. 2004-110386, filed Apr. 2, 2004, the entire contents of which are incorporated herein by reference.

### BACKGROUND OF THE INVENTION

1. Field of the Invention

The present invention relates to improvement of a write one type information recording medium capable of recording and reproducing information by using a short wavelength laser light beam such as, for example, a blue laser light beam.

2. Description of the Related Art

As is well known, in recent years, a medium for storing digital data has been increasingly important with the prevalence of personal computers and the like. For example, at present, an information recording medium capable of digitally recording and reproducing video information and voice information for a long period has become prevalent. Also, an information recording medium for digital recording and reproduction has been used for mobile devices such as cellular phones.

Here, as an information recording medium of this type, a disk shaped one is frequently utilized for a variety of reasons it has a large information recording capacity; it has a high random access performance capable of making a search for desired recorded information speedily; and moreover, it is small and light in weight, has excellent portability, and is inexpensive.

As such a disk shaped information recording medium, currently, there is mainly used: a so-called optical disk capable of recording and reproducing information in a non-contact manner by emitting a laser light. This optical disk primarily conforms to a compact disk (CD) standard or a digital versatile disk (DVD) standard, and has compatibility between both of these standards.

There are three types of optical disks: a reproduction only type which cannot record information such as CD-DA (digital audio), CD-ROM (read only memory), DVD-V (video), or DVD-ROM; a write-once which can write information only once such as CD-R (recordable) or DVD-R; and a rewritable type which can rewrite information many times such as CD-RW (rewritable) or DVD-RW.

Among them, as one capable of recording information, a write-once optical disk using an organic coloring matter for a recording layer is most prevalent because of its low manufacturing cost. This is because, if an information recording capacity exceeds 700 megabytes (MB), there is almost no use of erasing recorded information and rewriting a new item of information, and eventually recording information only once will suffice.

In a write-once optical disk using an organic coloring matter for a recording layer, after a laser light has been emitted to a recording region (track) defined by a groove, when a resin substrate is heated at its glass transition point Tg or more, the organic coloring matter film in the groove undergoes photochemical reaction, and a negative pressure is generated. As a result, a recording mark is formed by utilizing the fact that the resin substrate is deformed in the groove.

A typical organic coloring matter used for CD-R in which a wavelength of a laser light for recording and reproduction is about 780 nm includes a phthalo cyanine based coloring matter such as IRGAPHOR Ultragreen MX available from Ciba Speciality Chemicals. In addition, a typical organic coloring matter used for DVD-R in which a wavelength of a laser light for recording and reproduction is about 650 nm includes an azo metal complex based coloring matter available from Mitsubishi Chemicals Medium Co., Ltd.

In the meantime, in a next generation optical disk which achieves higher density and higher performance recording and reproduction as compared with a current optical disk, a blue laser light having a wavelength of about 405 nm is used as a laser light for recording and reproduction. However, an organic coloring matter material capable of achieving practically sufficient recording and reproducing features by using such a light with a small wavelength has not been developed yet.

That is, in the current optical disk for carrying out recording and reproduction by using a infrared laser light or a red laser light, there is used: an organic coloring matter material having a large absorption extremity at a wavelength side which is shorter than a wavelength (780 or 650 nm) of laser light for recording and reproduction. In this manner, the current optical disk achieves a so-called H-to-L (high-to-low) feature wherein the light reflectivity of a recording mark portion formed by emitting a laser light is lower than that before emitting the laser light.

In contrast, in the case where recording and reproduction are carried out by using a blue laser light, there is a problem that: an organic coloring matter material having an absorption extremity on a wavelength side which is shorter than a wavelength (405 nm) of the laser light for recording and reproduction is poor in stability and preservation durability relevant to an ultraviolet ray or the like; is poor in stability relevant to a heat; and is low in contrast and resolution of the recording mark.

In addition, blurring of the recording mark is probe to increase, and thus, this blurring affects the adjacent tracks, and the deterioration of cross-write feature is likely to occur. Further, there occurs inconvenience that a recording sensitivity is lowered and that a sufficient reproduction signal S/N (Signal to Noise) ratio and a bit error rate cannot be obtained.

Under a condition in which no information is recorded in the adjacent tracks, there is a case in which a predetermined recording sensitivity can be obtained. However, if information is recorded in the adjacent tracks, a reproduction signal S/N ratio is lowered because a cross write into the adjacent track is large. In addition, a bit error rate is higher, and a level suitable to practical use is not reached.

In Jpn. Pat. Appln. KOKAI Publication No. 2002-74740, there is disclosed an optical recording medium in which an absorption extremity of an organic coloring matter compound included in a recording layer exists at a wavelength side which is longer than a wavelength of a write light. However, in this document, there is nowhere described a configuration of improving performance of an optical disk itself such as a change of a light reflectivity before and after emission of a laser light, a reproduction signal S/N ratio, or a bit error rate.

### BRIEF SUMMARY OF THE INVENTION

According to one aspect of the present invention, there is provided a write-once information recording medium comprising: a transparent resin substrate having a concentrically or spirally shaped groove and a land formed thereon; and a recording film formed on the groove and the land of the transparent resin substrate, a recording mark being formed on the medium by emission of a short-wavelength laser light beam, wherein the light reflectivity of the recording mark portion formed by emission of the short-wavelength laser light beam is higher than the light reflectivity obtained before emission of the short-wavelength laser light beam, and a depth of the groove is in the range of 50 to 80 nm.

### BRIEF DESCRIPTION OF THE SEVERAL VIEWS OF THE DRAWING

FIG. 1 is a view for explaining four examples of organic coloring matter materials included in a recording film according to one embodiment of the present invention;

FIG. 2 is a characteristic view for explaining a change of absorbance relevant to a wavelength of a laser light with respect to each of three of the organic coloring matter materials in the embodiment;

FIG. 3 is a characteristic view for explaining a change of absorbance relevant to a wavelength of a laser light with respect to the remaining one of the organic coloring matter materials in the embodiment;

FIG. 4 is a view for explaining a part of a method for producing a disk stamper used for producing a write-once optical disk in the embodiment;

FIG. 5 is a view for explaining the remaining part of the method for producing the disk stamper used for producing the write-once optical disk in the embodiment;

FIG. 6 is a view for explaining a method for producing the write-once optical disk in the embodiment;

FIG. 7 is a view for explaining a spin coating condition for an organic coloring matter solution in accordance with the method for producing the write-once optical disk in the embodiment;

FIG. 8 is a view for explaining a relationship between a groove and a land of the write-once optical disk in the embodiment;

FIG. 9 is a view for explaining a wobble of a groove track of the write-once optical disk in the embodiment;

FIG. 10 is a are characteristic view for explaining a change of absorbance relevant to a wavelength of a laser light with respect to each of other seven examples of organic coloring matter materials included in the recording film in the embodiment;

FIG. 11 is a waveform chart showing an example of a signal recorded to carry out an evaluation test for evaluation of recording and reproduction in the write-once optical disk in the embodiment;

FIG. 12 is a view for explaining a measurement result obtained after an evaluation test of the write-once optical disk has been carried out for 11 examples of the organic coloring matter materials in the embodiment;

FIG. 13 is a view for explaining a measurement result obtained after a reproduction durability test of the write-once optical disk has been carried out for 8 examples of the organic coloring matter materials in the embodiment;

FIG. 14 is a characteristic view for explaining a relationship between a wobble depth and a simulated bit error rate of the write-once optical disk in the embodiment;

FIG. 15 is a characteristic view for explaining a relationship between a wobble depth and an S/N ratio during partial response of the write-once optical disk in the embodiment;

FIG. 16 is a view for explaining a measurement result when a reproduction test of the write-once optical disk has been carried out for three examples of the organic coloring matter materials in the embodiment;

FIG. 17 is a view for explaining a measurement result when another reproduction test of the write-once optical disk has been carried out for three examples of the organic coloring matter materials in the embodiment;

FIG. 18 is a microgram for explaining thickness of the recording film formed on the groove and the land of the write-once optical disk in the embodiment; and

FIG. 19 is a microgram for explaining a recording mark formed on the recording film of the write-once optical disk in the embodiment.

### DETAILED DESCRIPTION OF THE INVENTION

Hereinafter, one embodiment of the present invention will be described in detail with reference to the accompanying drawings. A write-once recording medium described in the embodiment comprises a transparent resin substrate formed of, for example, a synthetic resin material such as polycarbonate in a disk shape. On the transparent resin substrate, a groove is formed in a concentric shape or in a spiral shape. The transparent resin substrate can be manufactured by ejection molding using a stamper.

On the transparent resin substrate, a recording film including an organic coloring matter is formed so as to fill the groove. As the organic coloring matter which forms the recording film, there is used a coloring matter having its maximum absorption wavelength region which is shifted on a wavelength side which is longer than recording wavelength (405 nm). Also, the recording wavelength region has been designed so as to have equivalent light absorption without erasure of the absorption.

In this manner, in the case where focusing or tracking is carried out on a track before recording information by a laser light for recording, a low light reflectivity is obtained. A coloring matter decomposition reaction is generated by the laser light, and the light absorption rate is lowered, whereby the light reflectivity of a recording mark portion increases. Thus, a so-called L-to-H feature is achieved such that the light reflectivity of the recording mark portion formed by emitting the laser light is higher than the light reflectivity obtained before emitting the laser light.

The transparent resin substrate, in particular, a groove bottom may be deformed due to heat generation. In this case, a phase difference may occur with the reflection light.

The above organic coloring matter is liquefied by dissolving it in a solvent, and the resulting solution can be easily coated onto a transparent resin substrate surface in accordance with a spin coat technique. In this case, the film thickness can be managed with high precision by controlling the dilution rate by solvent and a rotation frequency during spin coating.

The organic coloring matter is composed of a coloring matter portion and an anion portion. As the coloring matter portion, a cyanine coloring matter, a styryl coloring matter or the like can be used. In particular, the cyanine coloring matter and styryl coloring matter are preferred because an absorption rate relevant to a recording wavelength can be easily controlled.

Among them, in a monomethine cyanine coloring matter having a monomethine chain, the recording film coated onto the transparent resin substrate is reduced in thickness, thereby making it possible to easily adjust absorbance in extreme absorption and a recording wavelength region (400 to 405 nm) in the range of 0.3 to 0.5, preferably to about 0.4. Thus, a recording and reproducing feature can be improved, and the light reflectivity and recording sensitivity can be well designed.

As the anion portion, an organic metal complex is preferably used in view of light stability. The metal complex has excellent light stability in particular when cobalt or nickel is used as a core metal.

An azo metal complex is most preferable. The decomposition property is also good in the case where 2,2,3,3-tetrafluoro-1-1propanol (TFP) is used as a solvent, and a solution for spin coating can be easily produced. In addition, recycling can be carried out after spin coating, thus making it possible to reduce the manufacturing cost of the optical disk.

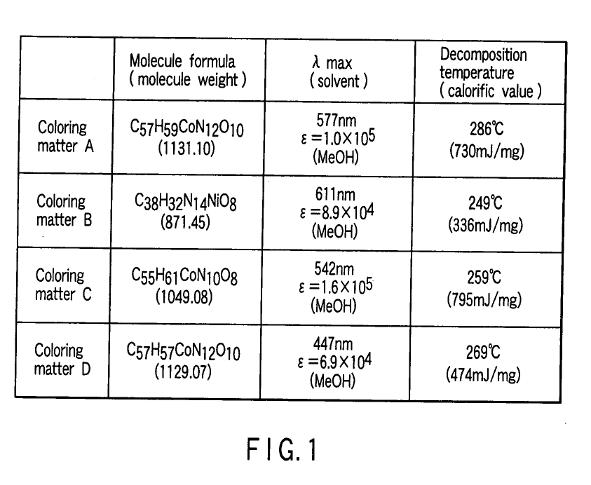

FIG. 1 shows four examples of coloring matters A to D as organic coloring matter materials. Coloring matter A has a coloring matter portion (cation portion) made of a styryl coloring matter, and has an anion portion made of an azo metal complex 1. Coloring matter C has a coloring matter portion (cation portion) made of a styryl coloring matter, and has an anion portion made of an azo metal complex 2. Coloring matter D has a coloring matter portion (cation portion) made of a monomethine cyanine coloring matter, and has an anion portion made of an azo metal complex 1. A simplex of the organic metal complex can also be used. For example, coloring matter B is a nickel complex coloring matter.

Then, on a disk substrate coated with the organic coloring matter thin film obtained after the above spin coating, a coloring matter is dried at a temperature of about 80° C. by using a hot plate or a clean oven. Then, on the thin film, a metal thin film serving as a light reflection film is formed by sputtering. As a material for the metal reflection film, for example, Au, Ag, Cu, Al or their alloy is used.

Then, an ultraviolet-ray-curable resin is spin-coated onto the metal film, and a protection disk substrate is attached to the film, whereby a write-once optical disk is manufactured as a write-once information recording medium.

Here, general formula 1 represents a general formula of a styryl coloring matter serving as each of the coloring matter portions of coloring matters A and C described above. General formula 2 represents a general formula of an azo metal complex serving as each of the anion portions of coloring matters A and C. In addition, general formula 3 represents a general formula of a monomethine cyanine coloring matter serving as the coloring matter portion of coloring matter D described above, and general formula 4 represents a general formula of an azo metal complex serving as the anion portion of coloring matter D.

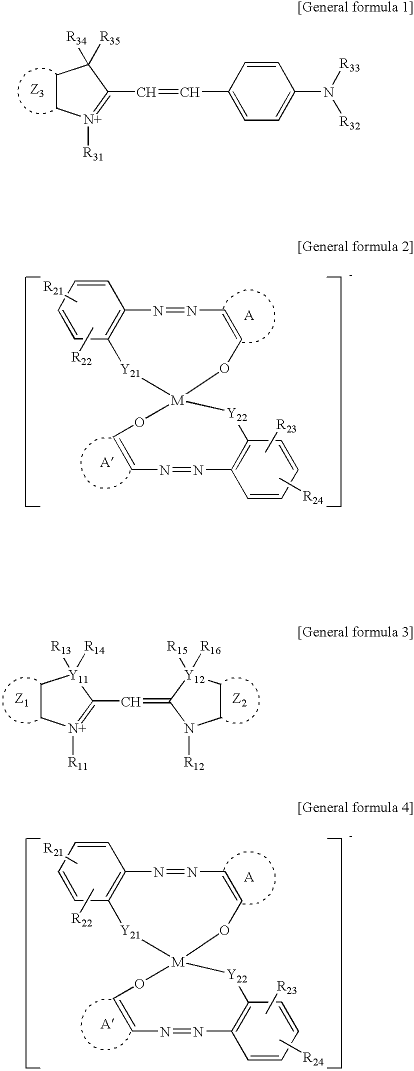

In the above general formula of the styryl coloring matter, Z3 represents an aromatic ring, and the aromatic ring may have a substituent. Y31 represents a carbon atom or a hetero atom. R31, R32, and R33 represent mutually same or different aliphatic hydrocarbon groups. These aliphatic hydrocarbon groups each may have a substituent. R34 and R35 each represent a hydrogen atom or a proper substituent, independently. When Y31 is a hetero atom, either or both of R34 and R35 are absent.

In addition, in the general formula of the monomethine cyanine coloring matter, Z1 and Z2 represent mutually same or different aromatic rings, and these aromatic rings each may have a substituent. Y11 and Y12 each represent a carbon atom or a hetero atom, independently. R11 and R12 represent aliphatic hydrocarbon groups, and these aliphatic hydrocarbon groups each may have a substituent. R13, R14, R15, and R16 each represent a hydrogen atom or a proper substituent, independently. When Y11 and T12 are hetero atoms, part or all of R13, R14, R15, and R16 are absent.

The monomethine cyanine coloring matter used in the embodiment is any one of mutually same or different coloring matter having one or more substituents at both ends of the monomethine chain possibly having one or more substituents, including coloring matters coupled with ring nucleus such as an imidazoline ring, an imidazole ring, a benzimidazole ring, an alpha-naphthoimidazole ring, a beta-naphthoimidazole ring, an indole ring, an isoindole ring, an indorenin ring, an isoindorenin ring, a benzoindorenin ring, a pyridinoindorenin ring, an oxazoline ring, an oxazole ring, an iso-oxazole ring, a benzo-oxazole ring, a pyridino-oxazole ring, an alpha-naphtho-oxazole ring, a beta-naphtho-oxazole ring, a selenazoline ring, a selenazole ring, a benzoselenazole ring, an alpha-naphthoselenazole ring, a beta-naphthoselenazole ring, a thiazoline ring, a thiazole ring, an isothiazole ring, a benzothiazole ring, an alpha-naphthothiazole ring, a beta-naphthothiazole ring, a tellurazoline ring, a tellurazole ring, a benzotellurazole ring, an alpha-naphthotellurazole ring, a beta-naththotellurazole ring, and further, an acrylidine ring, an anthracene ring, an isoquinoline ring, an isopyrrole ring, an imidanoxaline ring, an indandione ring, an indazole ring, an indaline ring, an oxadiazole ring, a carbazole ring, a xanthene ring, a xanazoline ring, a quinoxaline ring, a quinoline ring, a couromane ring, a cyclohexanedione ring, a cyclopenetanedione ring, a cinnoline ring, a thiodiazole ring, a thio-oxazolidone ring, a thiophene ring, a thionaphthene ring, a thiobarbituric acid ring, a thiohydantoin ring, a tetrazole ring, a triazine ring, a naphthalene ring, a naphthyridine ring, a piperazine ring, a pyradine ring, a pyrazole ring, a pyrazoline ring, a pyrazolidine ring, a pyrazolone ring, a pyrane ring, a pyridine ring, a pyridazine ring, a pyrimidine ring, a pyririum ring, a pyrrolidine ring, a pyrophosphate ring, a pyrrole ring, a phenadine ring, a phenanthridine ring, a phenanthrene ring, a phenanthrophosphate ring, a phthalazine ring, a preryzine ring, a furazane ring, a furan ring, a purin ring, a benzene ring, a benzo-oxazine ring, a benzopyrane ring, a morpholine ring and a rhodanine ring.

In the general formulas of the monomethine cyanine coloring matter and styryl coloring matter, Z1 to Z3 represent, for example, aromatic rings such as a benzene ring, a naphthalene ring, a pyridine ring, a quinoline ring, and a quinoxaline ring, and these aromatic rings may have one or plural substituents. Examples of the substituents include aliphatic hydrocarbon groups such as a methyl group, a trifluoromethyl group, an ethyl group, a propyl group, an isopropyl group, a butyl group, an isobutyl group, a sec-butyl group, a tert-butyl group, a pentyl group, an isopentyl group, a neopentyl group, a tert-pentyl group, a 1-methyl pentyl group, a 2-methyl pentyl group, a hexyl group, an isohexyl group, a 5-methyl hexyl group, a heptyl group and an octyl group; alicyclic hydrocarbon groups such as a cyclopropyl group, a cyclobutyl group, a cyclopentyl group and a cyclohexyl group; aromatic hydrocarbon groups such as a phenyl group, a biphenylyl group, an o-tolyl group, an m-tolyl group, a p-tolyl group, a xylyl group, a methycyl group, an o-cumenyl group, an m-cumenyl group and a p-cumenyl group; ether groups such as a methoxy group, a trifluoromethoxy group, an ethoxy group, a propoxy group, an isopropoxy group, a butoxy group, a sec-butoxy group, a tert-butoxy group, a pentyloxy group, a phenoxy group and a benzoyloxy group; ester groups such as a methoxycarbonyl group, a trifluoromethoxy carbonyl group, an ethoxycarbonyl group, a propoxycarbonyl group, an acetoxy group and a benzoyl oxy group; halogen groups such as a fluoro group, a chloro group, a bromo group and an iodo group; thio groups such as a methylthio group, an ehtylthio group, a propylthio group, a butylthio group and a phenylthio group; sulfamoyl groups such as a methyl sulfamoyl group, a dimethyl sulfamoyl group, an ethyl sulfamoyl group, a diethyl sufamoyl group, a propyl sulfamoyl group, a dipropyl sulfamoyl group, a butyl sulfamoyl group and a dibutyl sulfamoyl group; amino groups such as a primary amino group, a methylamino group, a dimethylamino group, an ethylamino group, a diethylamino group, a propylamino group, a dipropylamino group, an isopropylamino group, a diisopropylamino group, a butylamino group, a dibutylamino group and a piperidino group; carbamoyl groups such as a methyl carbamoyl group, a dimethyl carbamoyl group, an ethyl carbamoyl group, a diethyl carbamoyl group, a propyl carbamoyl group and a dipropyl carbamoyl group; and further, a hydroxyl group, a carboxy group, a cyano group, a nitro group, a sulfino group, a sulfo group, a mesyl group, etc. In general formula 3, Z1 and Z2 may be either mutually same or different.

In the general formulas of the monomethine cyanine coloring matter and styryl coloring matter, Y11, Y12, and Y31 represent carbon atoms or hetero atoms. The hetero atoms include a nitrogen atom, an oxygen atom, a sulfur atom, a selenium atom, and a tellurium atom, and other atoms selected from the elements of groups XV and XVI in the periodic table. The carbon atom in Y11, Y12, and Y31 may be an atomic group mainly comprising two carbon atoms such as an ethylene group and a vinylene group. In the general formula of the monomethine cyanine coloring matter, Y11 and Y12 may be either mutually same or different.

In the general formulas of the monomethine cyanine coloring matter and styryl coloring matter, R11, R12, R13, R32, and R33 represent aliphatic hydrocarbon groups. Examples of the aliphatic hydrocarbon groups include a methyl group, an ethyl group, a propyl group, an isopropyl group, an isopropenyl group, a 1-propenyl group, a 2-propenyl group, a butyl group, an isobutyl group, a sec-butyl group, a tert-butyl group, a 2-butenyl group, a 1,3-butadienyl group, a pentyl group, an isopentyl group, a neopentyl group, a tert-pentyl group, a 1-methylpentyl group, a 2-methylpentyl group, a 2-pentenyl group, a hexyl group, an isohexyl group, a 5-methylhexyl group, a peptyl group, an octyl group, and others. These aliphatic hydrocarbon groups may have one or plural substituents same as in Z1 to Z3.

Incidentally, R11 and R12 in the general formula of the monomethine cyanine coloring matter, and R13, R32, and R33 in the general formula of the styryl coloring matter may be either mutually same or different.

In the general formulas of the monomethine cyanine coloring matter and styryl coloring matter, R13 to R16, R34, and R35 represent hydrogen atoms or proper substituents, independently in the individual formulas. Examples of the substituents include aliphatic hydrocarbon groups such as a methyl group, a trifluoromethyl group, an ethyl group, a propyl group, an isopropyl group, a butyl group, an isobutyl group, a sec-butyl group, a tert-butyl group, a pentyl group, an isopentyl group, a neopentyl group, a tert-pentyl group, a 1-methyl pentyl group, a 2-methyl pentyl group, a hexyl group, an isohexyl group, a 5-methyl hexyl group, a heptyl group and an octyl group; ether groups such as a methoxy group, a trifluoromethoxy group, an ethoxy group, a propoxy group, a butoxy group, a tert-butoxy group, a pentyloxy group, a phenoxy group and a benzoyloxy group; halogen groups such as a fluoro group, a chloro group, a bromo group and an iodo group; and further, a hydroxy group, a carboxy group, a cyano group, and a nitro group. In the general formulas of the monomethine cyanine coloring matter and styryl coloring matter, if Y11, Y12, and Y31 are hetero atoms, part or all of R13 to R16 in Z1 and Z2, and part or all of R34 and R35 in Z3 are absent.

In the general formula of the azo metal complex, A and A′ represent mutually same or different five-membered to ten-membered heterocyclic groups, containing one or more hetero atoms selected from a nitrogen atom, an oxygen atom, a sulfur atom, a selenium atom, and a tellurium atom, such as a furyl group, a thienyl group, a pyridyl group, a piperidino group, a piperidyl group, a quinolyl group, and an iso-oxazolyl group. The heterocyclic group has one or more substituents, such as aliphatic hydrocarbon groups such as a methyl group, a trifluoromethyl group, an ethyl group, a propyl group, an isopropyl group, a butyl group, an isobutyl group, a sec-butyl group, a tert-butyl group, a pentyl group, an isopentyl group, a neopentyl group, a tert-pentyl group, a 1-methyl pentyl group, a 2-methyl pentyl group, a hexyl group, an isohexyl group and a 5-methyl hexyl group; ester groups such as a methoxycarbonyl group, a trifluoromethoxy carbonyl group, an ethoxycarbonyl group, a propoxycarbonyl group, an acetoxy group, a trifluoroacetoxy group and a benzoyl oxy group; aromatic hydrocarbon groups such as a phenyl group, a biphenylyl group, an o-tolyl group, a m-tolyl group, a p-tolyl group, an o-cumenyl group, an m-cumenyl group, a p-cumenyl group, a xylyl group, a mesityl group, a styryl group, a cinnamoyl group and a naphtyl group; and further, a carboxy group, a hydroxy group, a cyano group, and a nitro group.

The azo compound composing the azo organic metal oxide expressed in the general formula is prepared by ordinary method, by reaction between a diazonium salt having R21, R22, or R23, R24 corresponding to the general formula, and a heterocyclic compound having an active methylene group adjacent to a carboxyl group in the molecule, for example, an iso-oxazolone compound, an oxazolone compound, a thionaphthene compound, a pyrazolone compound, a barbituric acid compound, a hydantoin compound, and a rhodanine compound. Y21 and Y22 are mutually same or different hetero atoms selected from the elements of group XVI in the periodic table, such as an oxygen atom, a sulfur atom, a selenium atom, and a tellurium atom.

The azo metal complex expressed in the general formula is used in a form of metal complex, usually one or a plurality being coordinated in the metal (central atom). Examples of the metal element as a central atom include scandium, yttrium, titanium, zirconium, hafnium, panadium, niobium, tantalum, chromium, molybdenum, tungsten, manganese, technetium, rhenium, iron, lutenium, osmium, cobalt, rhodium, iridium, nickel, palladium, platinum, copper, silver, gold, zinc, cadmium, and mercury, and cobalt is most preferable.

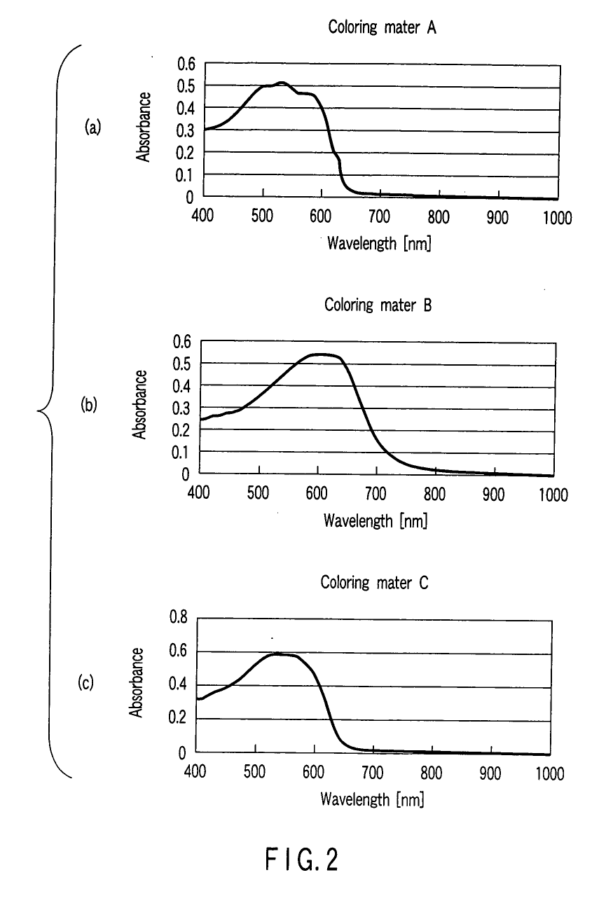

Reference numeral (a) of FIG. 2 shows a change of absorbance of the emitted laser light relevant to a wavelength in the above coloring matter A. Reference numeral (b) of FIG. 2 shows a change of absorbance of the emitted laser light relevant to a wavelength in the above coloring matter B. Reference numeral (c) of FIG. 2 shows a change of absorbance of the emitted laser light relevant to a wavelength in the above coloring matter C.

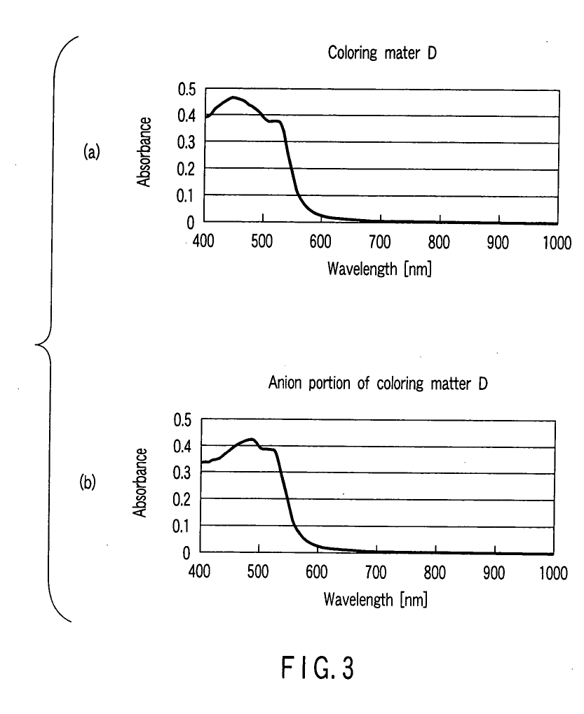

In addition, reference numeral (a) of FIG. 3 shows a change of absorbance of the laser light relevant to a wavelength in the above coloring matter D. Reference numeral (b) of FIG. 3 shows a change of absorbance of the emitted laser light relevant to a wavelength in the anion portion of the above coloring matter D.

As is evident from the features shown in FIG. 2 and FIG. 3, in the coloring matters A to D, their maximum absorption wavelength regions are shifted to a wavelength side which is longer than the recording wavelength (405 nm). A write-once optical disk described in the present embodiment is configured so as to have a so-called L to H feature in which organic coloring matters having the above-described features are included in a recording film and the light reflectivity obtained after emission of the laser light is higher than that obtained before emission of the laser light. In this manner, even if a short wavelength laser light such as a blue light laser light is used, it is possible to record and reproduce information with performance which is excellent in terms of preservation durability, a reproduction signal S/N ratio, a bit error rate and the like and which is sufficiently suitable to practical use at a high density.

That is, in this write-once optical disk, an extreme absorption wavelength of the recording film including the organic coloring matter is situated on a wavelength side which is longer than the wavelength of a laser light for recording. Thus, the absorption of a short wavelength light such as ultraviolet rays can be reduced to the minimum, thus resulting in excellent light stability and improved reliability of information recording and reproduction.

In addition, the light reflectivity is low at the time of information recording, and thus, no cross light due to reflection scattering occurs. Therefore, even in a state in which information has been recorded in the adjacent tracks, the lowering of the reproduction signal S/N ratio or the bit error rate can be restricted. Further, the contrast and resolution of the recording mark can be maintained with a high quality relevant to heat generation, and a recording sensitivity design can be easily made.

In order to obtain a good L-to-H feature, it is desirable that the absorbance in recording wavelength (405 nm) is 0.3 or more.

Here, in the groove serving as the recording and reproduction track of the write-once optical disk, its shape has a great effect on the recording and reproduction features. As a result of an utmost research of the Inventors, in particular, it was found out that the relationship between a groove width and a land width is important.

That is, the groove width is equal to the land width or if the groove width is smaller than the land width, it was found that the reproduction signal S/N ratio and bit error rate of the recorded information are prone to lower. Namely, it was found that good recording and reproduction features could be obtained when the groove width is larger than the land width.

In general, in order to record information in a write enable optical disk, it is necessary to record in advance a variety of address information such as a track number, a sector number, a segment number, and an error check and correction (ECC) block address number in an optical disk.

Means for recording such address information can be achieved by wobbling the groove in a radial direction of the optical disk. That is, the recording of the address information due to wobbling can be achieved by: means for modulating a wobble frequency in association with the address information; means for modulating a wobble amplitude in association with the address information; means for modulating a wobble phase in association with the address information; and means for modulating a polarity inversion interval of a wobble in association with the address information. In addition, means for utilizing a change of a land height as well as the wobble group, namely, means for embedding a pre-pit in the land can also be used.

Also, it was found out that the wobble amplitude, groove depth and the like, of such a groove have a great effect on the recording and reproduction features.

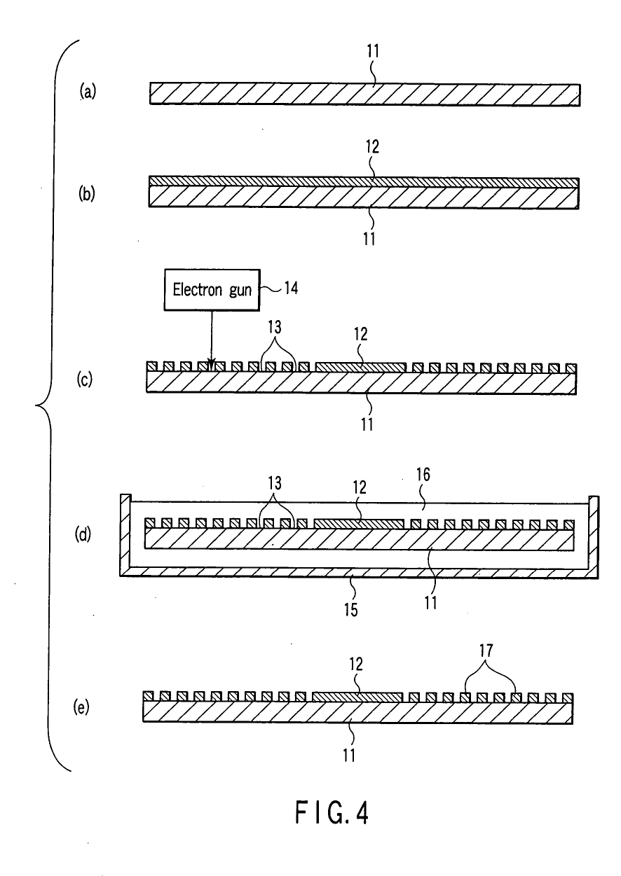

Now, a more specific description will be given below. First, a disk stamper for a high density R disk is prepared in accordance with the following procedures. That is, as shown in reference numeral (a) of FIG. 4, a semiconductor manufacturing silicon wafer 11 formed in a disk shape of a diameter of 200 mm and thickness of 0.725 mm is prepared.

The silicon wafer 11 is impregnated for 5 minutes in a mixture solution of a heated condensed sulfuric acid and a hydroperoxide water (liquid temperature of 100° C.). Next, the silicon wafer 11 is rinsed by impregnating it in ultra pure water, and is washed in an ultrasonic wave manner. Then, the wafer is impregnated in a 70° C. ultra pure water tank, and is dried by gradually pulling it up.

Then, as shown in reference numeral (b) of FIG. 4, an electron beam resist film 12 is formed on a surface of the silicon wafer 11. The electron beam resist film 12 is formed by spin coating on the surface of the silicon wafer 11 a resist solution obtained by mixing and stirring 86.2% by weight of an electron beam resist (ZEP520A7 available from Nihon Zeon Co., Ltd.) relevant to 100% by weight of an anizole solvent (ZEP-A available from Nihon Zeon Co., Ltd.).

Under the spin coating condition, the silicon wafer 11 is vacuum chucked on a spin table, the resist solution 12 is suspended via a 0.1-micron filter at the center of the silicon wafer 11 while rotation of the spin table stops, and then, the spin table is rotated at 2500 rpm.

Then, as shown in reference numeral (c) of FIG. 4, a groove 13 is formed in the electron beam resist film 12. This is accomplished by: placing the silicon wafer 11 coated with the electron beam resist film 12 in a vacuum vessel of an electron beam cutting machine; evaluating it in order of 10⁻⁵ Pa; rotating the silicon wafer 11: emitting an electron beam from an electron run 14 to the electron beam resist film 12; and recording a concentrically or spirally shaped groove pattern as an electron beam.

A groove pattern recording condition is such that an electron beam acceleration voltage is 50 kV, a beam current is 120 nA, a beam diameter is 110 nm, and a recording beam velocity is 1.1 m/sec. In addition, a recording region of the groove 13 is such that a radius of the silicon wafer 11 is in the range of 23 to 59 mm.

Then, the silicon wafer 11 obtained after the groove 13 has been recorded is taken out from the vacuum vessel of the electron beam cutting machine. As shown in reference numeral (d) of FIG. 4, the taken-out wafer 11 is impregnated in an organic developing liquid 16 contained in an impregnation vessel 15, and dip development is carried out, thereby forming a resist pattern of the groove 13.

Next, as shown in reference numeral (e) of FIG. 4, DC sputtering of an Ni film is carried out, thereby forming an Ni thin film 17 so as to be electrically conductive on the above-described resist pattern surface.

Thereafter, as shown in reference numeral (a) of FIG. 5, Ni electro-forming is carried out on the Ni thin film 17 to form an Ni electro-formed metal layer 18 having thickness of 247 microns. As shown in reference numeral (b) of FIG. 5, after the Ni electro-formed metal layer 18 has been released and spin washed, the residual resist on the surface is released by oxygen RIE. Then, as shown in reference numeral (c) of FIG. 5, a protection film is coated on the Ni electro-formed metal layer 18, the back face side is polished, an internal diameter and an external diameter are processed, and a disk stamper 19 is produced.

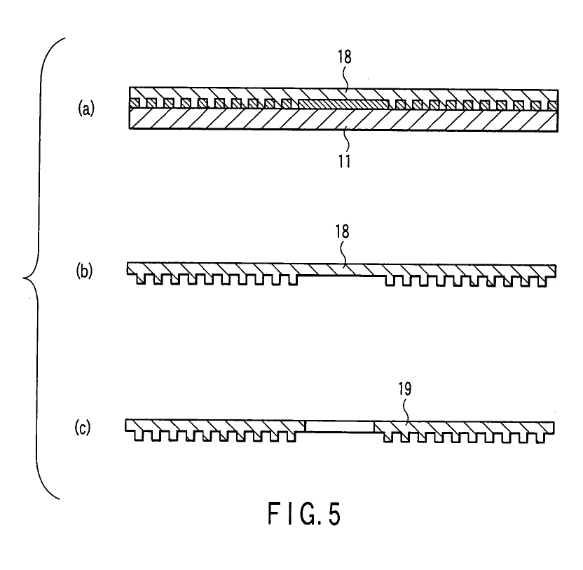

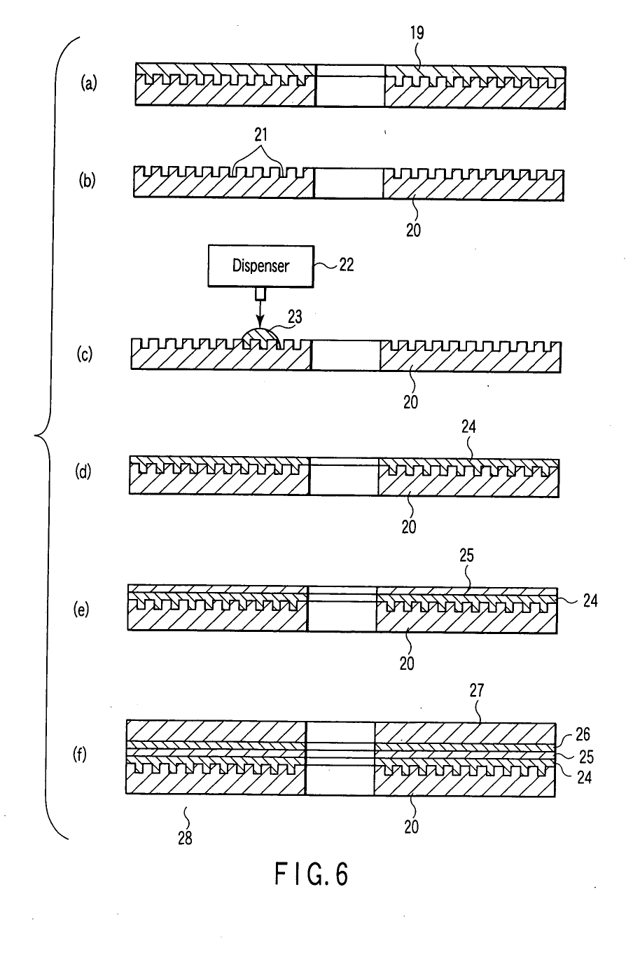

Next, a write-once optical disk is produced by using the disk stamper 19. That is, by using the disk stamper 19, a transparent disk substrate 20, as shown in reference numeral (b) of FIG. 6, made of polycarbonate having thickness of 0.6 mm is duplicated by carrying out ejection molding with an ejection molding device SD40 available from Sumitomo Heavy Industry Co., Ltd., as shown in reference numeral (a) of FIG. 6. A groove 21, of course, is formed on the disk substrate 20.

Then, as shown in reference numeral (c) of FIG. 6, by using a dispenser 22 having a nozzle diameter of 21 G, an organic coloring matter solution 23 described later, obtained by dissolving an organic coloring matter in a solvent is suspended on a face of the disk substrate 20 having the groove 21 formed thereon. Next, the disk substrate 20 is rotationally controlled, whereby, as shown in reference numeral (d) of FIG. 6, the organic coloring matter solution 23 is filled in the groove 21, and a recording film 24 is formed.

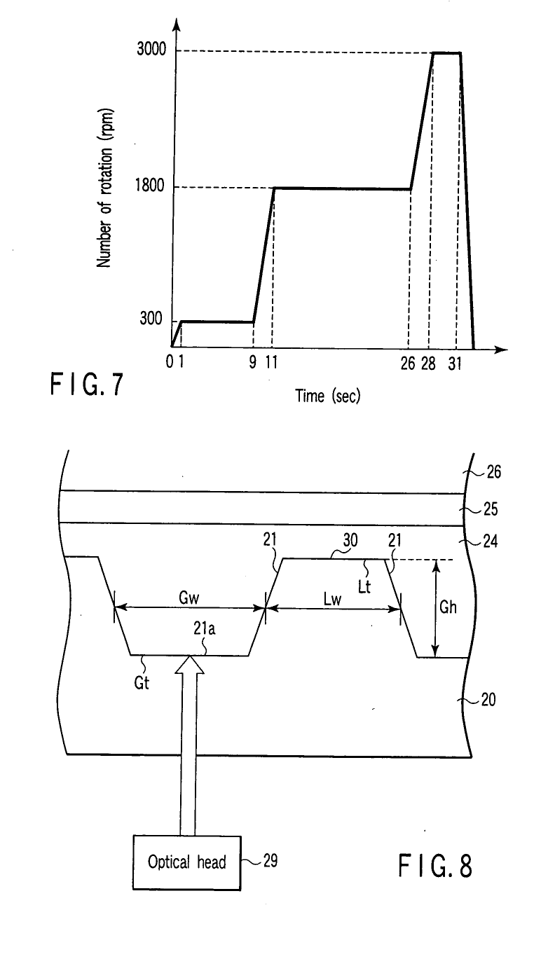

Under a spin coating condition for the recording film 24, as shown in FIG. 7, first, the disk substrate 20 is driven to rotate from its deactivated state up to 300 rpm within 1 second. While the disk substrate is maintained in this state for 8 seconds, the organic coloring matter solution 23 is coated by the dispenser 22. Subsequently, the number of rotation of the disk substrate 20 is increased to 1800 rpm within 2 seconds, and the disk substrate is maintained in this state for 15 seconds. Then, the number of rotation of the disk substrate 20 is increased to 3000 rpm within 2 seconds, and the disk substrate is maintained in this state for 3 seconds.

The film thickness of the recording film 24 can be controlled by controlling the number of rotation at a second stage. That is, the film thickness of the recording film 24 can be increased by reducing the number of rotation at the second stage.

Next, the disk substrate 20 coated with the recording film 24 is baked at 80° C. for 30 minutes by using a clean oven, and as shown in reference numeral (e) of FIG. 6, a 100 nm metal film 25 is sputtered on the recording film 24. As the metal film 25, although an Ag alloy containing 1% of AgND and 1% of Cu is used, pure silver can also be used.

Thereafter, as shown in reference numeral (f) of FIG. 6, an ultraviolet ray curable resin 26 is spin coated on the metal film 25, and a disk substrate 27 made of polycarbonate having thickness of 0.6 mm is attached, whereby a write-once optical disk (R disk) 28 including an organic coloring matter in the recording film 24 is produced.

In the write-once optical disk 28 produced as described above, as shown in FIG. 8, a laser light for recording and reproduction by an optical head 29 is made incident from a face opposite to a face coated with the recording film 24 of the disk substrate 20.

In this case, a bottom face 21a of the groove 21 formed on the disk substrate 20 and a land 30 sandwiched between the adjacent grooves 21 are obtained as tracks for recording information. A recording track formed by the bottom face 21a of the groove 21 is referred to as a groove track Gt, and a recording track formed by the land 30 is referred to as a land track Lt.

A difference in height of the groove track Gt face relevant to the land track Lt face is referred to as a groove depth Gh. Further, a width of the groove track Gt seen at a height which is substantially ½ of the groove depth Gh is referred to as a groove width Gw, and a width of the land track Lt seen at a height which is substantially ½ of the groove depth Gh is referred to as a land width Lw.

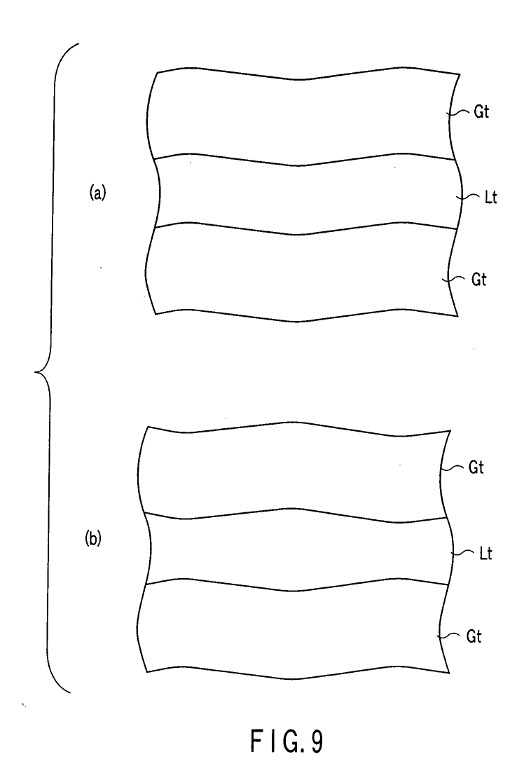

As described above, the groove track Gt is wobbled in order to record a variety of address information. Reference numeral (a) of FIG. 9 shows a case in which the adjacent groove tracks Gt are in an identical phase, and reference numeral (b) of FIG. 9 shows a case in which the adjacent groove tracks Gt are in a reversed phase. Depending on a region of the write-once optical disk 28, the adjacent groove tracks Gt have a variety of phase differences.

Now, generation of the above-described organic coloring matter solution 23 will be described here. As this organic coloring matter solution 23, there is used a solution having a solution concentration of 1.2% obtained by dissolving organic coloring matter powders of 1.2 g % by weight in a 100 ml TFP. A solution condition for a solvent is such that the coloring matter powers are put in the solvent, and the resultant solution is subjected to ultrasonic waves for 30 minutes.

As organic coloring matters, in addition to four types of coloring matters A to D described previously, seven types of mixed color matters F to L are produced by mixing two or more of these coloring matters.

Mixed color matter F is produced by adding 5% of coloring matter B to coloring matter D, namely, by mixing coloring matter B with coloring matter D at a ratio of 0.05 to 1 g.

Mixed color matter G is produced by mixing a monomethine cyanine coloring matter (azo metal complex 3 of the anion portion) serving as coloring matter E with coloring matter D at a ratio of 7:3 (=D:E), and further, adding 5% of coloring matter B, namely, mixing, at a ratio of 0.05 to 1 g, coloring matter B with the coloring matter obtained by mixing coloring matters D and E at a ratio of 7:3.

Mixed color matter H is produced by mixing coloring matter A with coloring matter D at a ratio of 1:1 (=D:A).

Mixed color matter I is produced by adding 10% of coloring matter B to coloring matter D, namely, by mixing coloring matter B with coloring matter D at a ratio of 0.10 to 1 g.

Mixed color matter J is produced by adding 15% of coloring matter B to coloring matter D, namely, by mixing coloring matter B with coloring matter D at a ratio of 0.15 to 1 g.

Mixed color matter K is produced by adding an azo metal complex 1 of an anion portion to coloring matter D, increasing an anion rate such that coloring matter portion:anion portion is 1:1.5, and further, adding 15% of coloring matter B.

Mixed color matter L is produced by adding an azo metal complex 1 of an anion portion to coloring matter D; increasing an anion rate such that coloring matter portion:anion portion is 1:2.0, and further, adding 15% of coloring matter B.

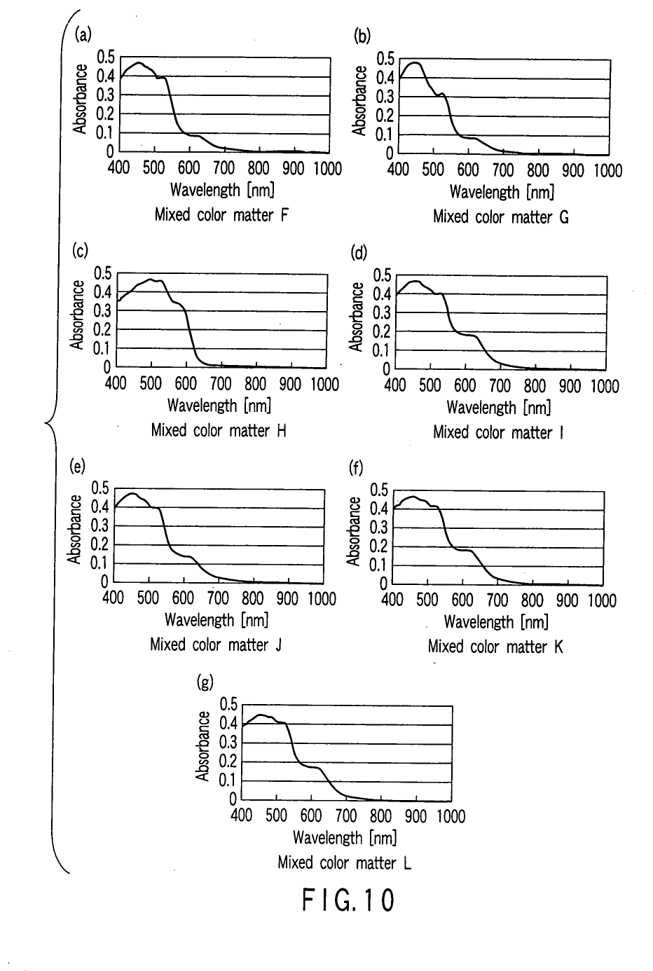

Reference numerals (a) to (g) of FIG. 10 each show a change of absorbance of the emitted laser light relevant to a wavelength in the above-described coloring matters F to L. In any of the mixed color matters F to L as well, the maximum absorption wavelength region is shifted to a wavelength which is longer than a recording wavelength (405 nm), and the absorbance in recording wavelength (405 nm) exists in the vicinity of substantial 0.4.

By using 11 types of organic coloring matters A to D and F to L described above, a write-once disk 28 is produced in accordance with the above-described method, and recording and reproduction are carried out on groove tracks Gt of the produced disks, thereby conducting an evaluation test. As an evaluation device, an optical disk evaluation device available from Pulse Tech Co., Ltd. is used.

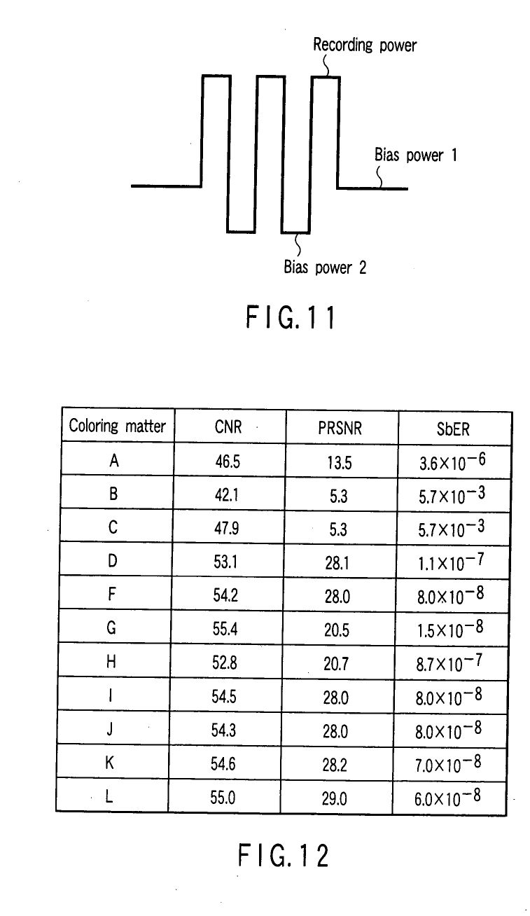

A testing condition is such that: an object lens aperture NA of the optical head 29 is 0.65; a wavelength of a laser light for recording and reproduction is 405 nm; and a linear velocity during recording and reproduction is 6.61 m/sec. A recording signal is obtained as random data modulated in the range of 8 to 12. That is, the recording signal is obtained as a waveform recorded by constant recording power and two types of bias powers 1 and 2 as shown in FIG. 11.

In addition, the track pitch is 400 nm, and the groove width Gw is “1.1” while the land width Lw is “1”. A wobble amplitude of the groove track Gt is 14 nm, and the groove depth Gh is 90 nm. Wobble phase modulation is used to record wobbling address information.

Here, evaluation features include: three types of measurements, i.e., a carrier noise ratio CNR of a reproduction signal, an S/N ratio PRSNR during partial response, and a simulated bit error rate SbER. PRSNR and SbER are measured in a state in which information has been recorded in the adjacent tracks.

FIG. 12 shows a measurement result of each of the write-once optical disks 28 using coloring matters A to D and F to L. Judging from the measurement result shown in FIG. 12, it is found that a measurement result of CNR, PRSNR, and SbER is not sufficient in each of the write-once optical disks 28 using coloring matters B and C.

In contrast, a good measurement result is obtained in each of the write-once optical disks 28 using coloring matters A, D, F, G, H, I, J, K, and L. Although a measurement result of the write-once optical disk 28 using coloring matter A is also good, a measurement result of the write-once optical disk 28 using coloring matter D is good in particular. Further, the measurement result of each of the write-once optical disks 28 using coloring matters F, I, J, K, and L is excellent.

Next, a test for evaluating a degree of degradation due to repetition reproduction is conducted for each of the write-once optical disks 28 using coloring matters D, F, G, H, I, J, K, and L, a measurement result of which has been good. That is, 10,000 reproductions are carried out at a reproduction laser power of 0.8 mW, and the degrees of degradation of PRSNR and SbER are measured.

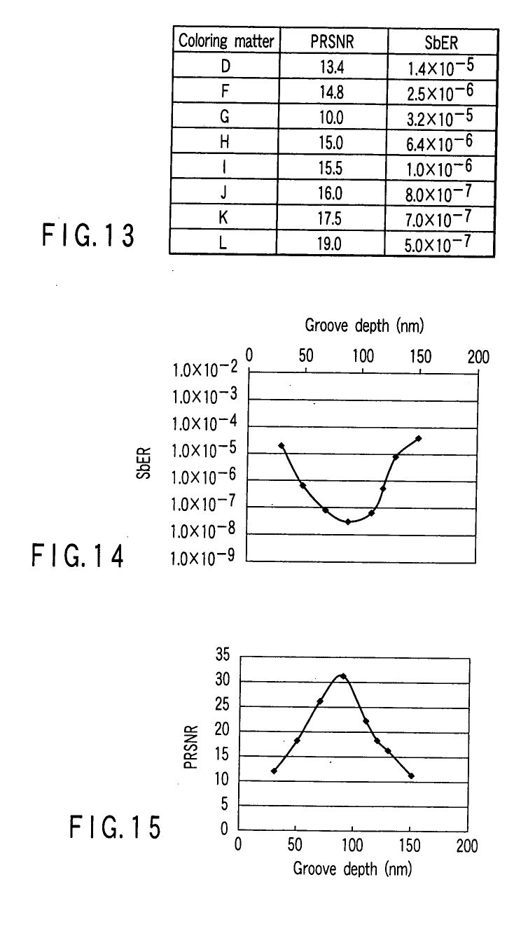

FIG. 13 shows a measurement result of each of the write-once optical disks 28 using coloring matters D, F, G, H, I, J, K, and L. It is found that the measurement result of each of PRSNR and SbER is not good in the write-once optical disk 28 using coloring matter G. The measurement result of each of the write-once optical disks 28 using coloring matters F, H, I, J, K, and L are good as compared with those of the write-once optical disk 28 using coloring matter D.

Among them, in particular, the measurement result of each of the write-once optical disks 28 using coloring matters J, K, and L is good, and the measurement result of the additional type optical disk 28 using coloring matter L is the best.

As has been described above, it is found that a material having a styryl coloring matter or a monomethine cyanine coloring matter in a coloring matter portion and having an azo metal complex in an anion portion is good as an organic coloring matter material used for the recording film 24.

In addition, it is found that a mixture of the styryl coloring matter and the monomethine cyanine coloring matter is good. Further, it is found that a material having a nickel metal complex added thereto is excellent. Furthermore, it is found that increasing a mixture ratio of the azo metal complex in the anion portion results in excellent reproduction light durability.

Next, eight types of disk stampers 19 are produced while groove depths Gh are defined as 30 nm, 50 nm, 70 nm, 90 nm, 110 nm, 120 nm, 130 nm, and 150 nm, respectively; a write-once optical disk 28 using coloring matter J is produced by using each of the disk stampers 19; and recording and reproduction are carried out on the groove track Gt, thereby conducting an evaluation test.

The evaluation features include three types of measurements, i.e., SbER, PRSNR, and CNR (Carrier to Noise Ratio) of a recording signal. FIG. 14 shows a measurement result of SbNR relevant to a groove depth Gh. FIG. 15 shows a measurement result of PRSNR relevant to the groove depth Gh.

With respect to CNR, it is defined as 35 dB when the groove depth Gh is 30 nm; 40 dB when the groove depth Gh is 50 nm; 53 dB when the groove depth Gh is 70 nm; 55 dB when the groove depth Gh is 90 nm; 51 dB when the groove depth Gh is 110 nm; 50 dB when the groove depth Gh is 120 nm; 45 dB when the groove depth Gh is 130 nm; and 38 dB when the groove depth is 150 nm.

Here, it is preferable that SbER be 5.0×10⁻⁵ or less. It is preferable that PRSNR is 15 or more. It is desirable that CNR is 40 dB or more, and more preferably 50 dB or more.

Thus, when these conditions are applied to FIGS. 14 and 15, and the above-described CNR, it is found that the groove depth Gh is in the range of 50 to 130 nm, thereby making it possible to obtain a good feature. More preferably, the groove depth Gh is in the range of 70 to 110 nm, and it is found that the best is in the vicinity of 90 nm.

The above-described SbER, PRSNR, and CNR show the measurement values in the case where a wobble depth Gh has been changed with respect to the write-once optical disk using coloring matter J. However, also with respect to the write-once optical disks using other coloring matter D, F, G, H, I, K, and L, a result of measuring SbER, PRSNR, and CNR in the case where the wobble depth Gh has been changed is obtained to be good in the range of 50 to 130 nm of the wobble depth Gh in any of the cases.

Further, when a groove reproduction signal (signals from grooves) has been investigated, it has been found that a push pull signal (I1−I2)pp/(I1+I2)DC is obtained in the range of 0.20 to 0.70 in the case of a Low-to-High disk. Furthermore, it has been found that a divided push pull signal [(I1−I2)/(I1+I2)]pp is in the range of 0.3 to 0.75. Moreover, it has found that an on-track signal Iot/I11t obtained by dividing a reflection light quantity level Iot when an unrecorded groove has been tracked by an upper level I11t in a long pit of a system lead-in region is within the range of 0.3 to 0.65.

In addition, although the phase depth of a groove is preferably 180° or less, it has found that there is no problem even if this depth is 90° or less.

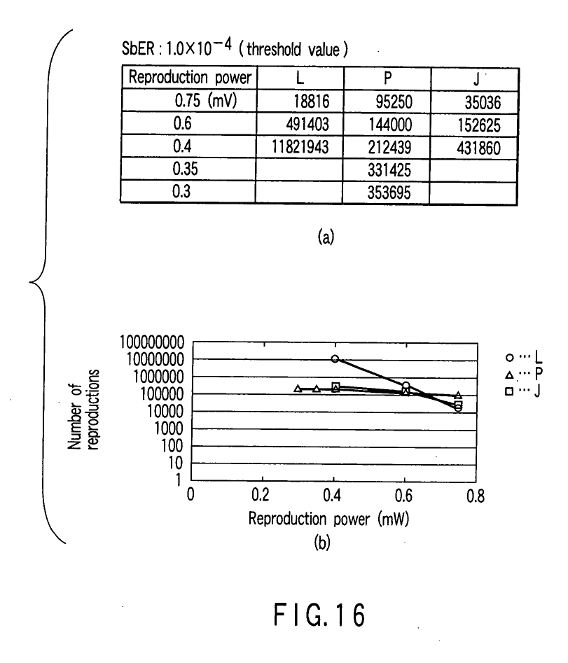

Reference numerals (a), (b) of FIG. 16 each show a measurement result of reproduction count relevant to reproduction power with respect to three types of write-once optical disks produced by using coloring matters J and L described above and coloring matter P obtained by using a single azo metal complex as an organic metal complex. In this case, the reproduction count assumes that SbER is 1.0×10⁻⁴ or less.

As coloring matter P, in chemical formula 1, there is used a coloring matter having Cu defined for M, CH₃ defined for R1 to R3, and Cl defined for R4 and R5. 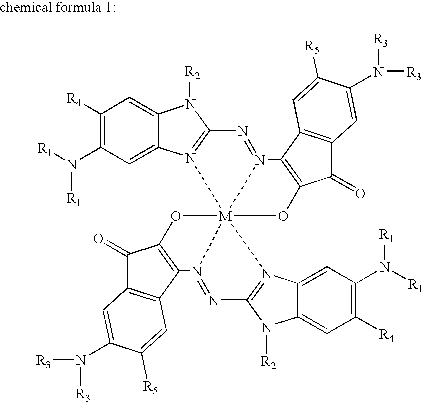
For example
M: Cu, Zn, Ni
R₁, R₂, R₃, R₄, R₅: CH₃, CxHy, H, Cl, F, NO₂, SO₂NHCH₃

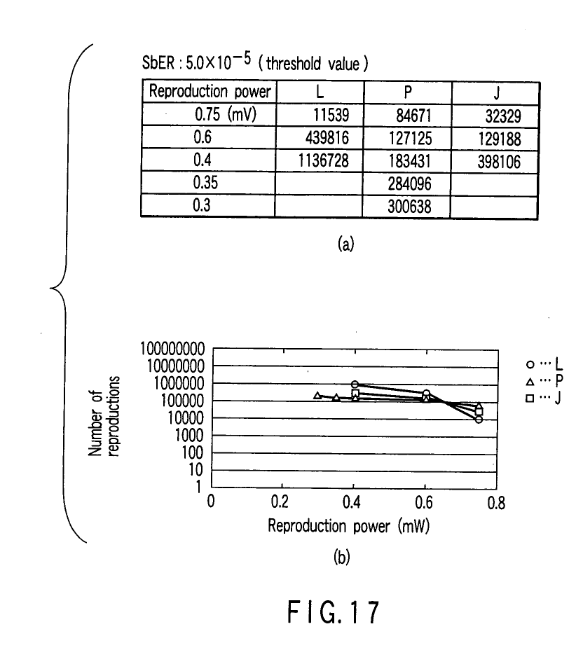

Reference numerals (a), (b) of FIG. 17 each show a measurement result of reproduction count relevant to reproduction power with respect to each of the write-once optical disks produced by using coloring matters J, L, and P described above. In this case, the reproduction count assumes that SbER is 5.0×10⁻⁵ or less.

As is evident from FIGS. 16 and 17, in any case, the write-once optical disk produced by using coloring matter L exhibits a good result in the vicinity of reproduction power of 0.4 mW.

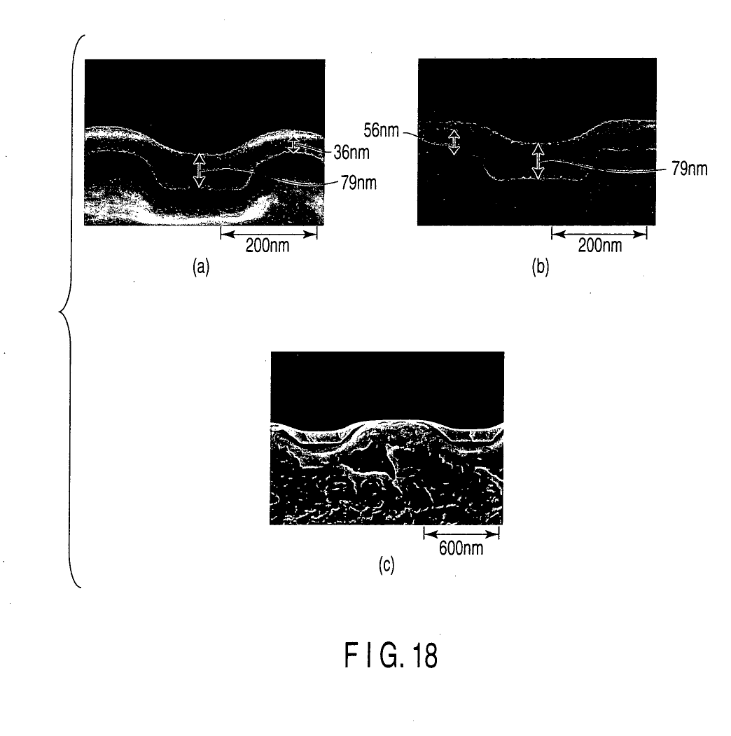

Here, in an example shown in reference numeral (a) of FIG. 18, the thickness of the recording film is set to 79 nm on the groove, and is set to 36 nm on the land. In an example shown in reference numeral (b) of FIG. 18, the above thickness is set to 79 nm on the groove, and is set to 56 nm on the land. In contrast, the thickness of a recording film in a conventional CD-R or DVD-R becomes very small as shown in reference numeral (c) of FIG. 18.

The recording film thickness on the groove is set in the range of 50 to 120 nm, and is set in the range of 20 to 70 nm, thereby making it possible to remarkably improve RPSNR, SbER, wobble cross talk, or radial deviation. In addition, a good result can be obtained by setting a ratio of the recording film thickness on the groove to the recording film thickness on the land to 1.3 to 3. Further, it is effective to set the groove width and the groove depth in the range of 220 to 270 nm and in the range of 50 to 80 nm, respectively.

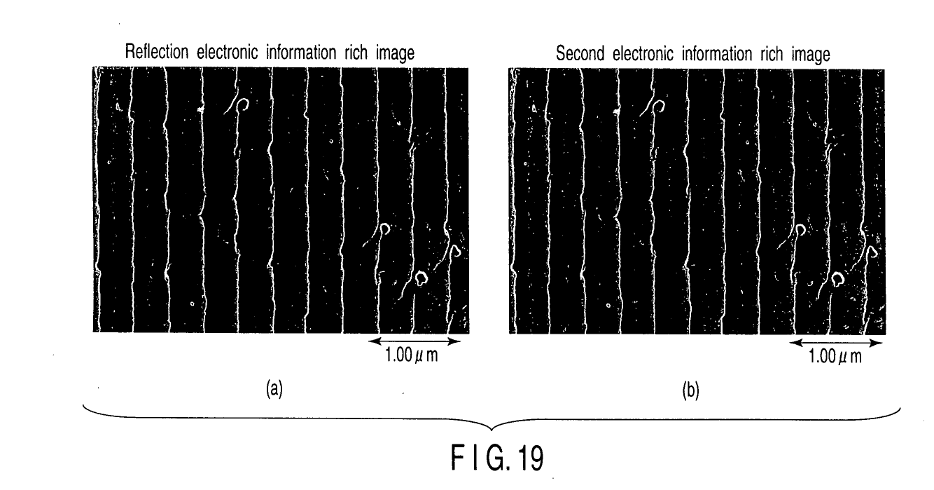

Moreover, by using the coloring matters described in the embodiment, as shown in reference numeral (a), (b) of FIG. 19, a recording mark without any irregularity change is formed on the recording film of the write-once optical disk. Conventionally, there has been a recording system formed in an irregular shape for deforming a substrate such as a punching system.

The present invention is not limited to the above-described embodiment. At the stage of implementation, various modifications of constituent elements can occur without departing the spirit of the invention. In addition, a variety of inventions can be formed by properly combining a plurality of constituent elements disclosed in the above embodiment. For example, some of all the constituent elements disclosed in the embodiment may be eliminated. Further, the constituent elements according to the different embodiments may be properly combined with each other.

1. A write-once information recording medium comprising:
a transparent resin substrate having a concentrically or spirally shaped groove and a land formed thereon; and
a recording film formed on the groove and the land of the transparent resin substrate, a recording mark being formed on the medium by emission of a short-wavelength laser light beam,
wherein a light reflectivity of the recording mark portion formed by emission of the short wave laser light beam is higher than a light reflectivity obtained before emission of the short-wavelength laser light beam, and a depth of the groove is in the range of 50 to 80 nm.

2. A write-once information recording medium according to claim 1, wherein a width of the groove is in the range of 220 to 270 nm.

3. A write-once information recording medium according to claim 1, wherein a simulated bit error rate is 5.0×10⁻⁵ or less.

4. A write-once information recording medium according to claim 1, wherein an S/N ratio during partial response is 15 or more.

5. A write-once information recording medium according to claim 1, wherein CNR of a recording signal is 40 dB or more.

6. A write-once information recording medium according to claim 1, wherein the recording film, a part or whole of which is composed of a coloring matter portion and an anion portion made of an organic metal complex, includes an organic coloring matter whose maximum absorption wavelength region exists on a wavelength side which is longer than a wavelength of the short-wavelength laser beam.

7. A write-once information recording medium according to claim 6, wherein the organic coloring matter has the coloring matter portion which is made of a styryl coloring matter or a monomethine cyanine coloring matter, and has the anion portion which is made of an organic metal complex that is mainly composed of a metal such as cobalt or nickel.

8. A write-once information recording medium according to claim 6, wherein the organic coloring matter is a mixed color matter of: a first coloring matter which is composed of a coloring matter portion made of a styryl coloring matter or a monomethine cyanine coloring matter and an anion portion made of an organic metal complex that is mainly composed of a metal such as cobalt or nickel; and a second coloring matter made of a metal complex.

9. A write-once information recording medium according to claim 6, wherein the organic coloring matter has the coloring matter portion which is made of a styryl coloring matter or a monomethine cyanine coloring matter, and has the anion portion made of an organic metal complex that is mainly composed of a metal such as cobalt or nickel, a rate of the anion portion being larger than a rate of the coloring matter portion.

10. A write-once information recording medium according to claim 6, wherein the organic coloring matter is a mixed color matter of: a first coloring matter which is composed of a coloring matter portion made of a styryl coloring matter or a monomethine cyanine coloring matter and an anion portion made of an organic metal complex that is mainly composed of a metal such as cobalt or nickel; and a second coloring matter made of an organic metal complex that is mainly composed of a metal such as cobalt or nickel.

11. A write-once information recording medium according to claim 6, wherein the organic coloring matter is a mixed color matter of: a first coloring matter which is composed of a coloring matter portion made of a styryl coloring matter or a monomethine cyanine coloring matter and an anion portion made of an organic metal complex that is mainly composed of a metal such as cobalt or nickel; a second coloring matter made of an organic metal complex that is mainly composed of a metal such as cobalt or nickel; and a third coloring matter made of a metal complex.

12. A write-once information recording medium according to claim 6, wherein the organic coloring matter is formed by: adding an azo metal complex of the anion portion to a coloring matter which is composed of a coloring matter portion made of a monomethine cyanine coloring matter and an anion portion made of an azo metal complex to obtain a ratio between the coloring matter portion and the anion portion as 1:1.5, and further, adding 15% of a nickel complex coloring matter.

13. A write-once information recording medium according to claim 6, wherein the organic coloring matter is formed by: adding an azo metal complex of the anion portion to a coloring matter which is composed of a coloring matter portion made of a monomethine cyanine coloring matter and an anion portion made of an azo metal complex to obtain a ratio between the coloring matter portion and the anion portion as 1:2.0, and further, adding 15% of a nickel complex coloring matter.

14. A write-once information recording medium according to claim 6, wherein the recording film, a part or whole of which is composed of an anion portion made of an organic metal complex, includes an organic coloring matter whose maximum absorption wavelength region exists on a wavelength side which is longer than a wavelength of the short-wavelength laser beam.
